(19) United States
(12) Patent Application Publication
(10) Pub. No.: US 2025/0360605 A1
(43) Pub. Date: Nov. 27, 2025

(54) RECIPROCATING TOOL, AND METHOD FOR CONTROLLING ELECTRIC MOTOR IN RECIPROCATING TOOL

(71) Applicant: MAKITA CORPORATION, Anjo-shi (JP)

(72) Inventors: Yuki KAWAI, Anjo-shi (JP); Naoya ASAMI, Anjo-shi (JP)

(73) Assignee: MAKITA CORPORATION, Anjo-shi (JP)

(21) Appl. No.: 19/217,581

(22) Filed: May 23, 2025

(30) Foreign Application Priority Data
May 24, 2024 (JP) 2024-085137

(51) Int. Cl. B25C 1/06

(52) U.S. Cl. CPC B25C 1/06

(57) ABSTRACT

One aspect of the present disclosure provides a reciprocating tool including a reciprocating member, an electric motor, a transmission device, a drive circuit, and a control circuit. The transmission device transmits a driving force of the electric motor to the reciprocating member at least in a stroke of the reciprocating member from second dead center to first dead center. The drive circuit delivers a motor current from a battery to the electric motor to thereby drive the electric motor in accordance with a drive signal received. The control circuit adjusts the drive signal, in response to a first condition being satisfied, such that the drive circuit reduces the motor current to thereby continue to drive the electric motor. The first condition is satisfied in response to (i) the drive circuit driving the electric motor, and (ii) a battery voltage falling below a first threshold voltage.

### CROSS-REFERENCE TO RELATED APPLICATIONS

The present application claims the benefit of Japanese Patent Application No. 2024-085137 filed on May 24, 2024 with the Japan Patent Office, the entire disclosure of which is incorporated herein by reference.

### BACKGROUND

The present disclosure relates to a reciprocating tool.

Japanese Patent No. 5564690 discloses an electric power tool configured to stop its motor regardless of an operating state of a trigger switch when a battery voltage falls below a first threshold voltage during an operation of the motor.

### SUMMARY

In a reciprocating tool such as an electric nailer, when the battery voltage falls below the first threshold voltage during the operation of the motor and the motor is stopped, a reciprocating member, such as a driver, may stop in an inappropriate position.

In one aspect of the present disclosure, it is desirable to provide a technique for inhibiting a reciprocating member in a reciprocating tool from being stopped in an inappropriate position when a battery voltage drops.

In the present disclosure, it should be noted that the terms such as “first” and “second” are intended simply to distinguish elements from each other, and are not intended to limit the order or the number of the elements. The first element may be referred to as the second element, and similarly, the second element may be referred to as the first element. In addition, the first element may be included without the second element, and similarly, the second element may be included without the first element.

One aspect of the present disclosure provides a reciprocating tool including a reciprocating member, an electric motor, a transmission device, a drive circuit, and a control circuit.

The reciprocating member is configured to reciprocate between first dead center and second dead center.

The electric motor is configured to generate a driving force.

The transmission device is configured to transmit the driving force of the electric motor to the reciprocating member at least in a stroke of the reciprocating member from the second dead center to the first dead center.

The drive circuit is configured (i) to receive a drive signal for driving the electric motor, and (ii) to deliver a motor current from a battery to the electric motor to thereby drive the electric motor, in accordance with the drive signal received.

The control circuit is configured (i) to output the drive signal to the drive circuit, and (ii) to adjust the drive signal, in response to a first condition being satisfied, such that the drive circuit reduces the motor current to thereby continue to drive the electric motor.

The first condition is satisfied in response to (i) the drive circuit driving the electric motor, and (ii) a battery voltage falling below a first threshold voltage. The battery voltage is output from the battery. The first threshold voltage is lower than a rated voltage of the battery.

In the reciprocating tool configured as above, even if the battery voltage falls below the first threshold voltage while the electric motor is being driven, the electric motor can continue to be driven.

Accordingly, in this reciprocating tool, the reciprocating member can be inhibited from being stopped in an inappropriate position when the battery voltage drops.

Another aspect of the present disclosure provides a method for controlling an electric motor in a reciprocating tool, the method including:
outputting, to a drive circuit of the reciprocating tool, a drive signal for driving the electric motor, the drive circuit being configured to deliver a motor current from a battery to the electric motor to thereby drive the electric motor in accordance with the drive signal;
transmitting a driving force of the electric motor to a reciprocating member of the reciprocating tool, the reciprocating member being configured to reciprocate between first dead center and second dead center, the driving force being transmitted at least from the second dead center to the first dead center; and
adjusting the drive signal such that the drive circuit reduces the motor current to thereby continue to drive the electric motor, in response to (i) the electric motor being driven, and (ii) the battery voltage falling below a threshold voltage, the battery voltage being output from the battery, and the threshold voltage being lower than a rated voltage of the battery.

With the method as above, it is possible to inhibit the reciprocating member in the reciprocating tool from being stopped in an inappropriate position when the battery voltage drops.

### BRIEF DESCRIPTION OF THE DRAWINGS

An example embodiment of the present disclosure will be described hereinafter with reference to the accompanying drawings, in which:

FIG. 1 is an external view of a reciprocating tool in an example embodiment;

FIG. 2 is a central longitudinal cross-sectional view of the reciprocating tool;

FIG. 3A is a cross-sectional view of the reciprocating tool taken by a line IIIA-IIIA in FIG. 1, and FIG. 3B is a top view of the reciprocating tool including a perspective view of a motor housing;

FIGS. 4A through 4D show one sequence of mechanical operations in the reciprocating tool;

FIGS. 5A through 5E show operations of a holder corresponding to the one sequence of mechanical operations in the reciprocating tool;

FIG. 6 is a circuit diagram showing an electrical configuration of the reciprocating tool;

FIG. 7 is a timing diagram showing an outline of an electrical operation of the reciprocating tool;

FIG. 8 is a timing diagram showing an outline of a low-voltage drive operation;

FIG. 9 is a timing diagram showing another outline of the low-voltage drive operation;

FIG. 10 is a flowchart showing a flow of a main routine executed by a control circuit;

FIG. 11 is a flowchart showing a flow of a motor control process executed by the control circuit;

FIG. 12 is a flowchart showing a flow of a driving process executed by the control circuit;

FIG. 13 is a flowchart showing a flow of a low-voltage drive determination process executed by the control circuit;

FIG. 14A is a flowchart showing a flow of part of an output duty ratio setting process executed by the control circuit; and

FIG. 14B is a flowchart showing a flow of the rest of the output duty ratio setting process.

### DETAILED DESCRIPTION OF EXEMPLARY EMBODIMENTS

### 1. Overview of Embodiments

One embodiment may provide a reciprocating tool including at least any one of:
Feature 1: a reciprocating member configured to reciprocate between first dead center and second dead center;
Feature 2: an electric motor configured to generate a driving force;
Feature 3: a transmission device configured to transmit the driving force of the electric motor to the reciprocating member at least in a stroke of the reciprocating member from the second dead center to the first dead center;
Feature 4: a drive circuit configured (i) to receive a drive signal for driving the electric motor, and (ii) to deliver a motor current from a battery to the electric motor to thereby drive the electric motor, in accordance with the drive signal received;
Feature 5: a control circuit configured (or programmed) (i) to output the drive signal to the drive circuit, and (ii) to adjust the drive signal, in response to a first condition being satisfied, such that the drive circuit reduces the motor current to thereby continue to drive the electric motor;
Feature 6: the first condition is satisfied in response to (i) the drive circuit driving the electric motor, and (ii) a battery voltage falling below a first threshold voltage;
Feature 7: the battery voltage is output from the battery; and
Feature 8: the first threshold voltage is lower than a rated voltage of the battery.

In the reciprocating tool including at least Features 1 through 8, even if the battery voltage falls below the first threshold voltage while the electric motor is driven, the electric motor can continue to be driven, and thus the reciprocating member can be inhibited from being stopped in an inappropriate position.

Examples of the reciprocating tool include an electric nailer, an electric rebar tier, an electric rebar cutter, an electric lubricator, and an electric inflator. Examples of the electric lubricator include an electric grease gun.

Examples of the electric motor include a DC motor, an AC motor, and a stepper motor. Examples of the DC motor include a brushless DC motor, and a brushed DC motor.

Examples of the drive circuit include a full-bridge circuit and a half-bridge circuit.

In one embodiment, the control circuit may be integrated into a single electronic unit or a single electronic device or a single circuit board.

In one embodiment, the control circuit may be a combination of two or more electronic circuits or two or more electronic units or two or more electronic devices provided separately on or in the reciprocating tool.

In one embodiment, the control circuit may include a microcomputer (or a microcontroller or a microprocessor), wired logic, an application specific integrated circuit (ASIC), an application specific standard product (ASSP), a programmable logic device (PLD) (such as a field programmable gate array (FPGA)), a discrete electronic component, and/or any combination of the foregoing.

One embodiment may include, in addition to or in place of at least any one of Features 1 through 8, at least any one of:
Feature 9: a power-supply circuit configured to generate, based on the battery voltage, a power-supply voltage for operating the control circuit;
Feature 10: the first threshold voltage is set higher than a second threshold voltage such that the battery voltage exceeds the second threshold voltage when the control circuit adjusts the drive signal in response to the first condition being satisfied; and
Feature 11: the second threshold voltage corresponds to a lower limit of the battery voltage required for the power-supply circuit to generate the power-supply voltage.

In the reciprocating tool including at least Features 1 through 11, it is possible to inhibit the control circuit from stopping its operation and causing the reciprocating member to be stopped in an inappropriate position, due to the battery voltage falling below the second threshold voltage while the electric motor is driven.

One embodiment may include, in addition to or in place of at least any one of Features 1 through 11, at least any one of:
Feature 12: the drive signal is in the form of a pulse-width modulated signal having an output duty ratio; and
Feature 13: the drive circuit is configured to deliver, to the electric motor, the motor current based on the output duty ratio.

In the reciprocating tool including at least Features 1 through 8, 12, and 13, the motor current can be adjusted by adjusting the output duty ratio.

One embodiment may include, in addition to or in place of at least any one of Features 1 through 13:
Feature 14: the control circuit is configured (or programmed) to reduce the output duty ratio to a duty ratio capable of driving the reciprocating member in response to the first condition being satisfied.

In the reciprocating tool including at least Features 1 through 8, and 12 through 14, it is possible to continue driving the electric motor by reducing the output duty ratio to the duty ratio as above.

One embodiment may include, in addition to or in place of at least any one of Features 1 through 14, at least any one of:
Feature 15: the control circuit is configured (or programmed) to gradually increase the output duty ratio at a specified rate of increase over time in response to a second condition being satisfied;
Feature 16: the second condition is satisfied in response to (i) the drive circuit driving the electric motor and (ii) the battery voltage changing from a first magnitude to a second magnitude;
Feature 17: the first magnitude is smaller than the first threshold voltage; and
Feature 18: the second magnitude is greater than or equal to the first threshold voltage.

In the reciprocating tool including at least Features 1 through 8, and 12 through 18, when the second condition is satisfied, the battery voltage can increase while an excessive motor current is inhibited from flowing through the electric motor.

One embodiment may include, in addition to or in place of at least any one of Features 1 through 18, at least any one of:
Feature 19: the control circuit is configured (or programmed) to set the output duty ratio to a lower limit duty ratio in response to the first condition being satisfied; and
Feature 20: the lower limit duty ratio corresponds to a duty ratio for the electric motor to generate a minimum driving force required for driving the reciprocating member.

In the reciprocating tool including at least Features 1 through 8, 12 through 14, and 20, the motor current flowing from the battery to the electric motor can be quickly reduced without causing the reciprocating member to stop. Consequently, the battery voltage can quickly increase.

One embodiment may include, in addition to or in place of at least any one of Features 1 through 20, at least any one of:
Feature 21: the control circuit is configured (or programmed) to gradually reduce the output duty ratio at a specified rate of decrease over time in response to a third condition being satisfied; and
Feature 22: the third condition is satisfied in response to the output duty ratio being set to the lower limit duty ratio and the battery voltage subsequently falling below the first threshold voltage again.

In the reciprocating tool including at least Features 1 through 8, 12 through 14, and 20 through 22, the motor current can be slowly reduced when the battery voltage falls below the first threshold voltage again.

One embodiment may include, in addition to or in place of at least any one of Features 1 through 22, at least any one of:
Feature 23: the control circuit is configured (or programmed) to disable (or prohibit) an output of the drive signal for an nth drive of the electric motor in response to a fourth condition being satisfied, where n is any integer greater than or equal to two;
Feature 24: the fourth condition is satisfied in response to (i) the battery voltage falling below a third threshold voltage before an (n−1)th drive of the electric motor, and (ii) the battery voltage falling below a fourth threshold voltage during the (n−1)th drive of the electric motor, where n is any integer greater than or equal to two;
Feature 25: the third threshold voltage is higher than the first threshold voltage; and
Feature 26: the fourth threshold voltage is (i) higher than the first threshold voltage, and (ii) lower than the third threshold voltage.

In the reciprocating tool including at least Features 1 through 8, and 23 through 26, when the fourth condition is satisfied in the (n−1)th drive of the electric motor, the nth drive of the electric motor can be disabled (or prohibited).

One embodiment may include, in addition to or in place of at least any one of Features 1 through 26, at least any one of:
Feature 27: the control circuit is configured (or programmed) to enable (or permit) the output of the drive signal for the nth drive of the electric motor in response to a fifth condition being satisfied, where n is any integer greater than or equal to two; and
Feature 28: the fifth condition is satisfied in response to the battery voltage exceeding the third threshold voltage before the (n−1)th drive of the electric motor, where n is any integer greater than or equal to two.

In the reciprocating tool including at least Features 1 through 8, and 23 through 28, when the fifth condition is satisfied in the (n−1)th drive of the electric motor, the nth drive of the electric motor can be performed.

One embodiment may include, in addition to or in place of at least any one of Features 1 through 28,
Feature 29: the transmission device includes a reducer (i) having a preset deceleration ratio, and (ii) configured to convert the driving force of the electric motor into a decelerated output and transmit the decelerated output to the reciprocating member.

In the reciprocating tool including at least Features 1 through 8 and 29, the reciprocating member can be driven from at least the second dead center to the first dead center with a torque proportional to the deceleration ratio of the reducer. Consequently, even if the motor current is largely reduced while the electric motor is driven, the reciprocating member can continue to be driven.

Examples of the reducer include a gear reducer. Examples of the gear reducer include a parallel gear reducer, an orthogonal gear reducer, and a concentric gear reducer. Examples of the concentric gear reducer include a planetary gear reducer.

One embodiment may include, in addition to or in place of at least any one of Features 1 through 29, at least any one of:
Feature 30: a first manual switch configured to be manually operated by a user of the reciprocating tool; and
Feature 31: the control circuit is configured (or programmed) to output the drive signal to the drive circuit in response to at least the first manual switch being or having been manually operated.

One embodiment may include, in addition to or in place of at least any one of Features 1 through 31, at least any one of:
Feature 32: a pressing member configured to be pressed against a workpiece by the user;
Feature 33: a second manual switch configured to be manually operated by the pressing member being pressed against the workpiece; and
Feature 34: the control circuit is configured (or programmed) to output the drive signal to the drive circuit based on both the first manual switch and the second manual switch being or having been manually operated.

In the reciprocating tool including at least Features 1 through 8, and 30 through 34, the electric motor can be inhibited from being accidentally driven when the pressing member is not pressed against the workpiece, in other words, when the user is not machining the workpiece.

One embodiment may include, in addition to or in place of at least any one of Features 1 through 34, at least any one of:
Feature 35: a cylinder (or a chamber) containing compressed gas therein;
Feature 36: a piston that (i) is inside the cylinder, and (ii) urges the reciprocating member toward the second dead center by the compressed gas; and
Feature 37: the reciprocating member is configured to be driven from the first dead center to the second dead center by the piston.

In the reciprocating tool including at least Features 1 through 8, and 35 through 37, the reciprocating member can be moved from the first dead center to the second dead center by a pressure applied from the compressed gas to the piston.

Examples of the compressed gas include compressed air, and compressed inert gas. The compressed air may be compressed dry air. Examples of the compressed inert gas include compressed nitrogen gas and compressed noble gas.

One embodiment may include, in addition to or in place of at least any one of Features 1 through 37:
Feature 38: the reciprocating member is configured (i) to be positioned at the first dead center in response to the piston being positioned at its top dead center, and (ii) to be positioned at the second dead center in response to the piston being positioned at its bottom dead center.

In the reciprocating tool including at least Features 1 through 8, and 35 through 38, the maximum pressure of the compressed gas is applied to the reciprocating member, and the reciprocating member can be moved from the first dead center to the second dead center. In addition, the reciprocating member moving from the second dead center to the first dead center can be decelerated by the pressure of the compressed gas.

One embodiment may include, in addition to or in place of at least any one of Features 1 through 38, at least any one of:
Feature 39: the transmission device includes a cam (i) including an outer circumference having two or more pins aligned in a circumferential direction of the cam, and (ii) configured to rotate by the driving force of the electric motor; and
Feature 40: the reciprocating member (i) extends between the first dead center and the second dead center, (ii) includes two or more racks in its extending direction, and (iii) is configured to be driven from the second dead center to the first dead center by each of the two or more racks engaging with a corresponding one of the two or more pins.

In the reciprocating tool including at least Features 1 through 8, 39 and 40, the reciprocating member can be moved at least from the second dead center to the first dead center by the cam.

One embodiment may include, in addition to or in place of at least any one of Features 1 through 40,
Feature 41: a battery attachment portion configured such that the battery is detachably attached thereto.

One embodiment may provide a method including at least any one of:
Feature 42: outputting, to a drive circuit of a reciprocating tool, a drive signal for driving an electric motor of the reciprocating tool;
Feature 43: the drive circuit is configured to deliver a motor current from a battery to the electric motor to thereby drive the electric motor in accordance with the drive signal;
Feature 44: transmitting a driving force of the electric motor to a reciprocating member of the reciprocating tool;
Feature 45: the reciprocating member is configured to reciprocate between first dead center and second dead center;
Feature 46: the driving force is transmitted at least from the second dead center to the first dead center;
Feature 47: adjusting the drive signal such that the drive circuit reduces the motor current to thereby continue to drive the electric motor, in response to (i) the electric motor being driven, and (ii) a battery voltage falling below a threshold voltage;
Feature 48: the battery voltage is output from the battery; and
Feature 49: the threshold voltage is lower than a rated voltage of the battery.

With the method including at least Features 41 through 49, it is possible to inhibit the reciprocating member in the reciprocating tool from being stopped in an inappropriate position when the battery voltage drops.

In one embodiment, Features 1 through 49 may be combined in any combination.

In one embodiment, any of Features 1 through 49 may be excluded.

### 2. Specific Example Embodiment

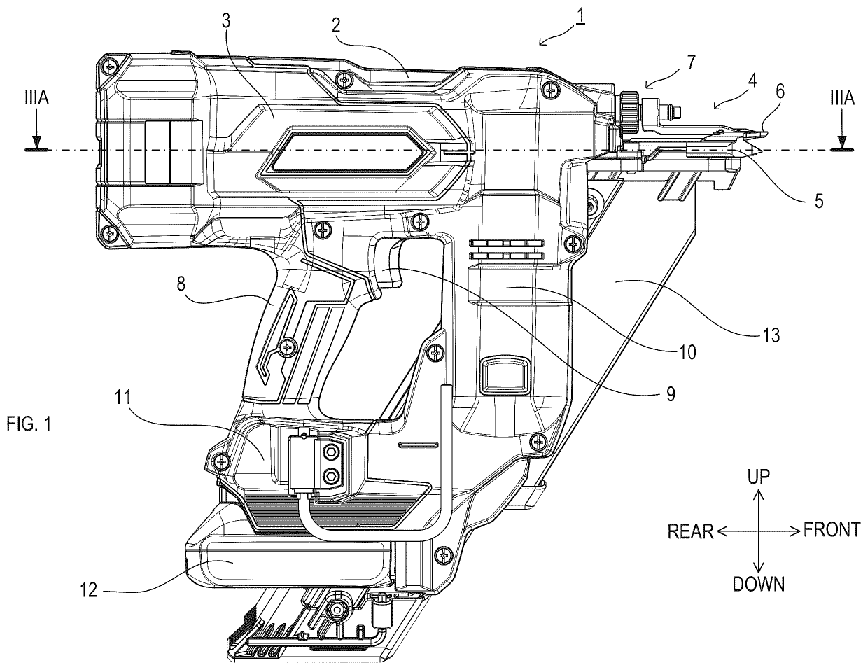

A specific example embodiment will be described below. This specific example embodiment provides a reciprocating tool 1 shown in FIG. 1.

The terms “up,” “down,” “front,” “rear,” “left,” and “right” in the following description or the drawings are used only to facilitate easy understanding of the structure of the reciprocating tool 1 and are not intended to limit the orientation of the reciprocating tool 1. The reciprocating tool 1 can be oriented in any direction.

### 2-1. Overall Structure of Reciprocating Tool

As shown in FIG. 1, the reciprocating tool 1 in the present embodiment is an electric nailer configured to drive a nail into a workpiece. Examples of the nail used in the reciprocating tool 1 include a staple, a pin nail, a finish nail, and a brad nail. In another embodiment, the reciprocating tool 1 may be any other type of reciprocating tool, such as an electric rebar tier, an electric rebar cutter, an electric lubricator, and an electric inflator.

The reciprocating tool 1 includes a housing 2. The housing 2 includes a driving assembly housing 3 extending from a rear end to a front end of the housing 2 (in other words, in a direction in which a nail is ejected). The reciprocating tool 1 includes an ejector 4 in front of the driving assembly housing 3. The ejector 4 includes a guide 5 configured to guide a nail ejected from the reciprocating tool 1 to a workpiece. In the present embodiment, the guide 5 protrudes from inside the driving assembly housing 3 to the front of the reciprocating tool 1. The ejector 4 includes a pressing member (or a contact) 6 configured to be pressed against a workpiece. The pressing member 6 is disposed above the guide 5, and protrudes most forward in the reciprocating tool 1. The ejector 4 includes a link mechanism 7 coupled to the pressing member 6.

The housing 2 includes a grip 8 extending downward from approximately a center of the driving assembly housing 3. The grip 8 is configured to be held in one hand of a user of the reciprocating tool 1. The grip 8 includes a trigger 9 on its upper front side. The trigger 9 is configured to be pulled by the user's finger (for example, index finger).

The housing 2 includes a motor housing 10 extending downward from a front part of the driving assembly housing 3. The housing 2 includes a battery attachment portion 11 extending from a lower end of the motor housing 10 to a lower end of the grip 8. The battery attachment portion 11 is configured to detachably attach a battery pack 12 to the battery attachment portion 11.

The reciprocating tool 1 includes a magazine 13 extending from a lower part of the guide 5 to a lowest end of the reciprocating tool 1 on a left side of the housing 2. The magazine 13 is configured to deliver one or more nails contained therein into the guide 5 one by one. In the present embodiment, the magazine 13 extends diagonally rearward.

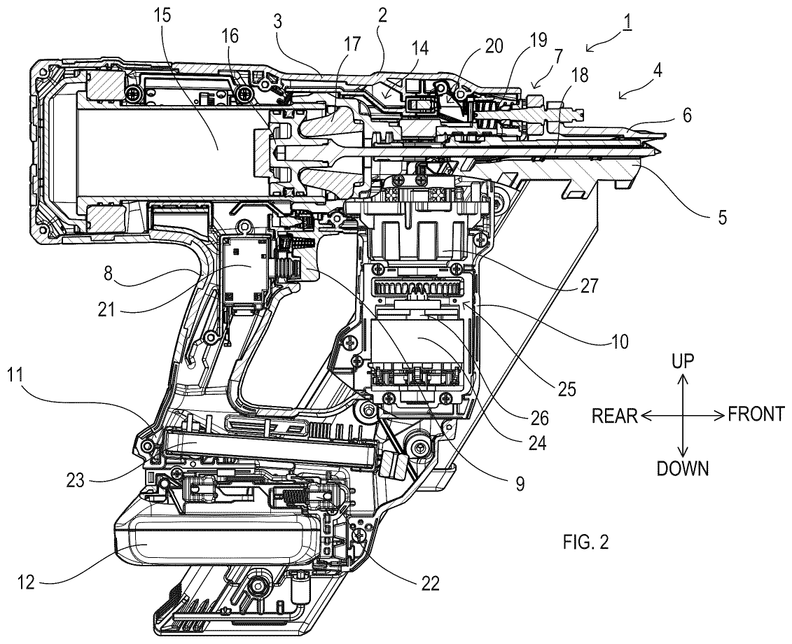

As shown in FIG. 2, the driving assembly housing 3 accommodates a driving assembly 14 configured to drive a nail.

The driving assembly 14 includes a cylinder 15 extending from a rear end of the driving assembly housing 3 to approximately the center thereof.

The cylinder 15 contains compressed gas therein. In the present embodiment, the compressed gas is compressed dry air. In another embodiment, the compressed gas may be compressed inert gas, such as compressed nitrogen gas and compressed noble gas.

The cylinder 15 includes a piston 16 therein. The piston 16 is configured to move between rear and front ends of the cylinder 15 while sealing the cylinder 15. The driving assembly 14 includes a bumper 17 at the front end of the cylinder 15. The bumper 17 is configured to receive and stop the piston 16 when the piston 16 reaches the front end of the cylinder 15.

The driving assembly 14 includes a reciprocating member (or a driver) 18 passing through the bumper 17 and coupled to the piston 16. The reciprocating member 18 extends from the piston 16 toward a tip end of the guide 5. The reciprocating member 18 is configured to move toward the tip end of the guide 5 by a pressure applied to the piston 16 from the compressed gas. In other words, the piston 16 urges the reciprocating member 18 toward the tip end of the guide 5 by the compressed gas. In the present embodiment, the reciprocating member 18 has a length such that (i) a tip end of the reciprocating member 18 reaches the tip end of the guide 5 when the piston 16 reaches the front end of the cylinder 15 (in other words, bottom dead center of the piston 16), and (ii) the tip end of the reciprocating member 18 retreats (or retracts) into the driving assembly housing 3 when the piston 16 reaches the rear end of the cylinder 15 (in other words, top dead center of the piston 16).

The link mechanism 7 of the ejector 4 includes a spring 19 inside the driving assembly housing 3. The link mechanism 7 is configured to move the pressing member 6 rearward of the reciprocating tool 1 in response to a tip end of the pressing member 6 being pressed against a workpiece, while urging the pressing member 6 forward by the spring 19.

The driving assembly housing 3 accommodates a contact switch 20 above the reciprocating member 18. The contact switch 20 is configured to be pressed (in other words, turned ON) by the link mechanism 7 when the pressing member 6 is pressed against a workpiece.

The grip 8 accommodates a trigger switch 21. The trigger switch 21 is configured to be pressed (in other words, turned ON) when the trigger 9 is pulled. The trigger switch 21 is configured to be turned OFF when the user's finger is released from the trigger 9.

The battery attachment portion 11 accommodates a connector 22 configured to be detachably coupled to the battery pack 12 attached to the battery attachment portion 11. The battery attachment portion 11 accommodates a controller 23 above the connector 22.

The motor housing 10 accommodates an electric motor 24 in its lower part. In the present embodiment, the electric motor 24 is a three-phase brushless DC motor. In another embodiment, the electric motor 24 may be a single-phase brushless DC motor, a two-phase brushless DC motor, a four-phase or more brushless DC motor, a brushed DC motor, an AC motor, or a stepper motor.

The motor housing 10 accommodates a transmission device 25 above the electric motor 24. The transmission device 25 is coupled to a rotor 26 of the electric motor 24, and is configured to transmit a driving force of the electric motor 24 to the reciprocating member 18.

More specifically, the transmission device 25 includes a reducer 27 (i) having a preset deceleration ratio, and (ii) configured to convert the driving force of the electric motor 24 into a decelerated output and transmit the decelerated output to the reciprocating member 18. Accordingly, the transmission device 25 can transmit, to the reciprocating member 18, a torque proportional to the deceleration ratio of the reducer 27. In the present embodiment, the reducer 27 is a concentric gear reducer, more specifically, a planetary gear reducer. In another embodiment, the reducer 27 may be a parallel gear reducer or an orthogonal gear reducer, depending on the structure of the transmission device 25.

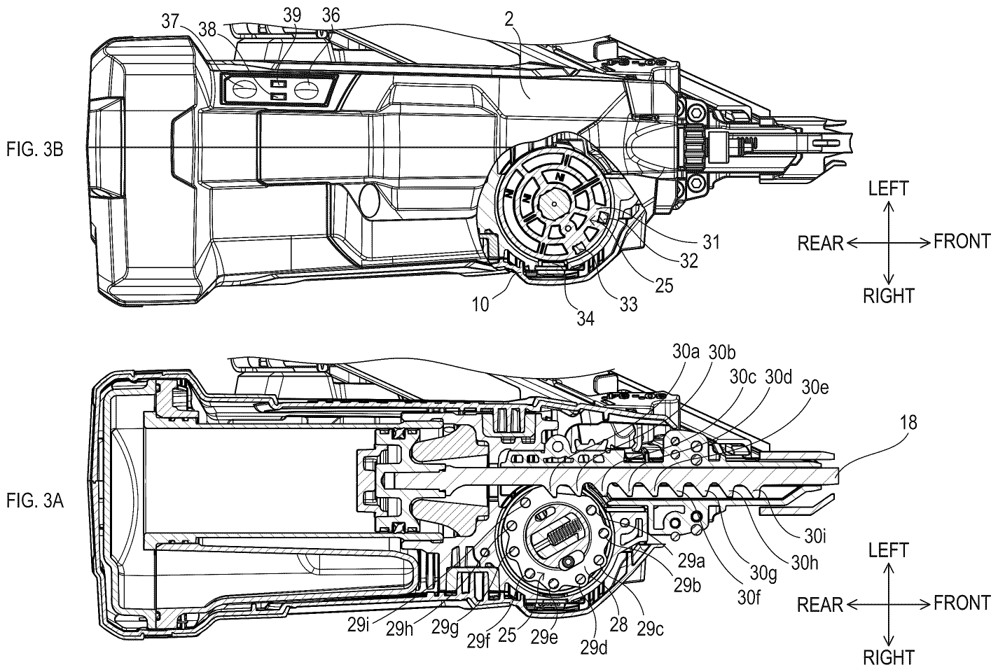

As shown in FIG. 3A, the transmission device 25 includes a cam 28 above the reducer 27. In the present embodiment, the cam 28 is disc-shaped. The cam 28 includes first through ninth pins 29a through 29i on its outer circumferential edge along its circumferential direction. The cam 28 is configured to rotate by receiving the output of the reducer 27. More specifically, the cam 28 rotates counterclockwise around the rotor 26 of the electric motor 24 when viewed from above the reciprocating tool 1.

The reciprocating member 18 includes first through ninth racks 30a through 30i on its right side. The first through ninth racks 30a through 30i are aligned in an extending direction of the reciprocating member 18. The first through ninth racks 30a through 30i correspond to the first through ninth pins 29a through 29i, respectively. The first through ninth pins 29a through 29i engage with the first through ninth racks 30a through 30i, respectively, to thereby transmit the driving force of the electric motor 24 to the reciprocating member 18.

As shown in FIG. 3B, the transmission device 25 includes a holder 31 above the cam 28. In the present embodiment, the holder 31 is disc-shaped. The holder 31 is a non-magnetic member. The holder 31 includes a first magnet 32 on its top surface. In the present embodiment, the first magnet 32 is disposed on the top surface of the holder 31 such that its south pole faces outward in a radial direction of the holder 31. In another embodiment, the first magnet 32 may be disposed on the top surface of the holder 31 such that its north pole faces outward in the radial direction of the holder 31.

The holder 31 includes a second magnet 33 on its top surface. In the present embodiment, the second magnet 33 is disposed on the top surface of the holder 31 such that its north pole faces outward in the radial direction of the holder 31. In another embodiment, the second magnet 33 may be disposed on the top surface of the holder 31 such that its south pole faces outward in the radial direction of the holder 31.

The holder 31 is configured to rotate by receiving the output of the reducer 27. More specifically, the holder 31, together with the cam 28, rotates counterclockwise around the rotor 26 of the electric motor 24 when viewed from above the reciprocating tool 1.

The motor housing 10 includes a Hall effect IC 34 on its right inner wall. The Hall effect IC 34 faces an outer circumferential edge of the holder 31. The Hall effect IC 34 is configured (i) to detect the south pole of the first magnet 32 when the first magnet 32 comes close to the Hall effect IC 34, and (ii) to detect the north pole of the second magnet 33 when the second magnet 33 comes close to the Hall effect IC 34.

The housing 2 includes, on a left side of its upper rear part, a main power switch 36 configured to be pressed by the user to turn the power of the reciprocating tool 1 ON or OFF.

The housing 2 includes a mode selection switch 37 adjacent to the main power switch 36. The mode selection switch 37 is configured to be pressed by the user to select operation modes of the reciprocating tool 1.

The housing 2 includes a first indicator 38 between the main power switch 36 and the mode selection switch 37. The first indicator 38 is turned ON (i) when the reciprocating tool 1 is set to a later-described single shot mode, or (ii) when malfunction occurs in the reciprocating tool 1.

The housing 2 includes a second indicator 39 adjacent to the first indicator 38. The second indicator 39 is turned ON (i) when the reciprocating tool 1 is set to a later-described multiple shot mode, or (ii) when malfunction occurs in the reciprocating tool 1.

### 2-2. Mechanical Operation of Reciprocating Tool

### 2-2-1. Mechanical Operations of Reciprocating Member and Cam

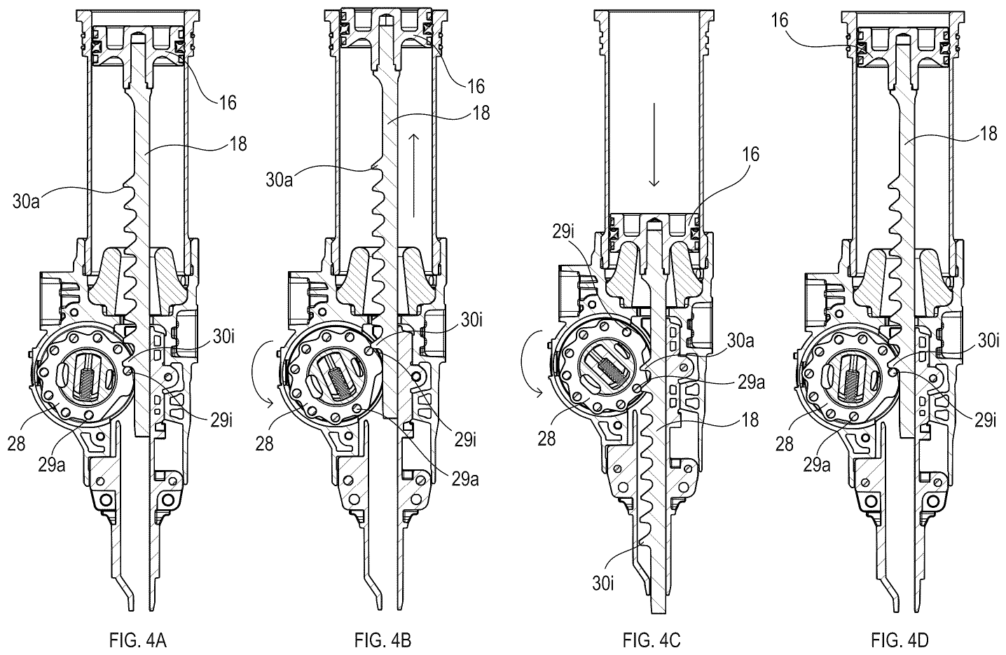

Referring to FIGS. 4A through 4D, operations of the reciprocating member 18 and the cam 28 will be described. In many cases, the user uses the reciprocating tool 1 with a front end of the reciprocating tool 1 facing downward, when machining a workpiece. Thus, in FIGS. 4A through 4D, the front end of the reciprocating tool 1 faces downward.

As shown in FIG. 4A, the reciprocating member 18 is normally held in a standby position. The standby position is set immediately before top dead center of the reciprocating member 18. In the present embodiment, the standby position is a position to stop the reciprocating member 18 as well as a position where the reciprocating member 18 waits for the next reciprocating motion of the reciprocating member 18. In the standby position, the first through eighth pins 29a through 29h of the cam 28 are disengaged from the first through eighth racks 30a through 30h of the reciprocating member 18, and only the ninth pin 29i of the cam 28 is engaged with the ninth rack 30i of the reciprocating member 18. At this point in time, the piston 16 is located immediately before its top dead center.

When the electric motor 24 is driven and the cam 28 rotates counterclockwise, the reciprocating member 18 is driven from the standby position to its top dead center, as shown in FIG. 4B. At this point in time, the piston 16 also reaches its top dead center.

When the reciprocating member 18 reaches its top dead center and the ninth pin 29i is disengaged from the ninth rack 30i, the reciprocating member 18 is driven to its bottom dead center by the pressure of the compressed gas applied from the piston 16, as shown in FIG. 4C. Consequently, a nail delivered into the guide 5 is struck by the reciprocating member 18 and driven into a workpiece. When the reciprocating member 18 reaches its bottom dead center, the piston 16 also reaches its bottom dead center. The cam 28 continues to rotate after the ninth pin 29i is disengaged from the ninth rack 30i, and the first through ninth pins 29a through 29i again engage with the first through ninth racks 30a through 30i, respectively. Then, as shown in FIG. 4D, the reciprocating member 18 returns to the standby position, and the cam 28 is stopped.

### 2-2-2. Mechanical Operation of Holder

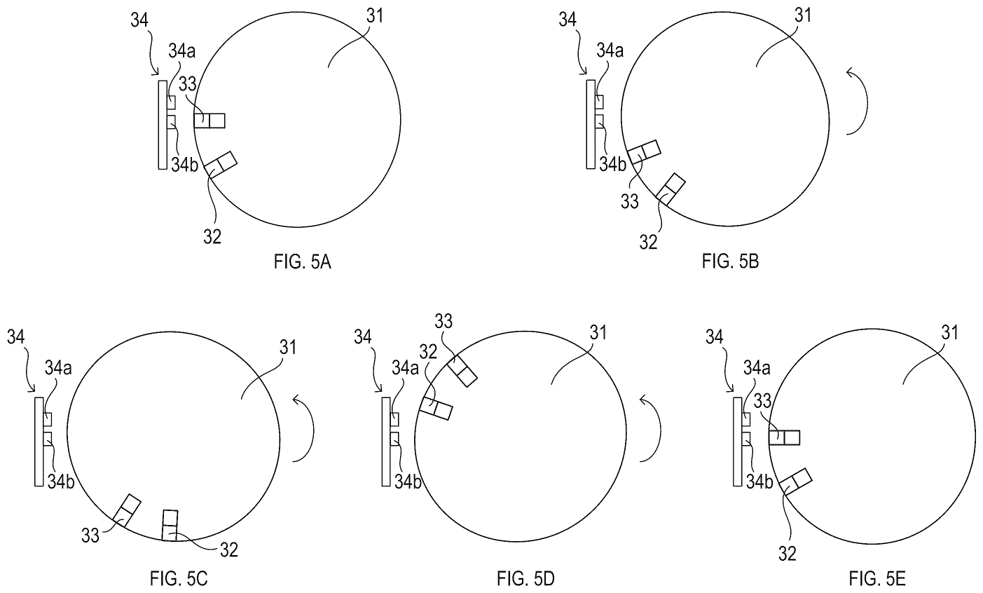

When the electric motor 24 is driven, the holder 31, together with the cam 28, rotates as shown in FIGS. 5A through 5E. FIGS. 5A through 5C and 5E respectively correspond to FIGS. 4A through 4D. FIG. 5D shows a rotational position of the holder 31 when the cam 28 is positioned between (i) the rotational position of the cam 28 shown in FIG. 4C, and (ii) the rotational position of the cam 28 shown in FIG. 4D.

The Hall effect IC 34 includes a first Hall element 34a. In the present embodiment, the first Hall element 34a is configured to detect the south pole of the first magnet 32. In another embodiment, when the first magnet 32 is disposed on the top surface of the holder 31 such that its north pole faces outward in the radial direction of the holder 31, the first Hall element 34a may be configured to detect the north pole of the first magnet 32.

The Hall effect IC 34 includes a second Hall element 34b. In the present embodiment, the second Hall element 34b is configured to detect the north pole of the second magnet 33. In another embodiment, when the second magnet 33 is disposed on the top surface of the holder 31 such that its south pole faces outward in the radial direction of the holder 31, the second Hall element 34b may be configured to detect the south pole of the second magnet 33.

The first magnet 32 is disposed before the second magnet 33 in the rotational direction of the holder 31 (i.e., the counterclockwise direction in FIGS. 5A through 5E).

More specifically, as shown in FIG. 5D, the first magnet 32 is disposed on the top surface of the holder 31 such that its south pole faces the first Hall element 34a at the timing to start preparing to stop the cam 28.

As shown in FIGS. 5A and 5E, the second magnet 33 is disposed on the top surface of the holder 31 such that its north pole faces the second Hall element 34b when the reciprocating member 18 is in the standby position.

### 2-3. Electrical Configuration of Reciprocating Tool

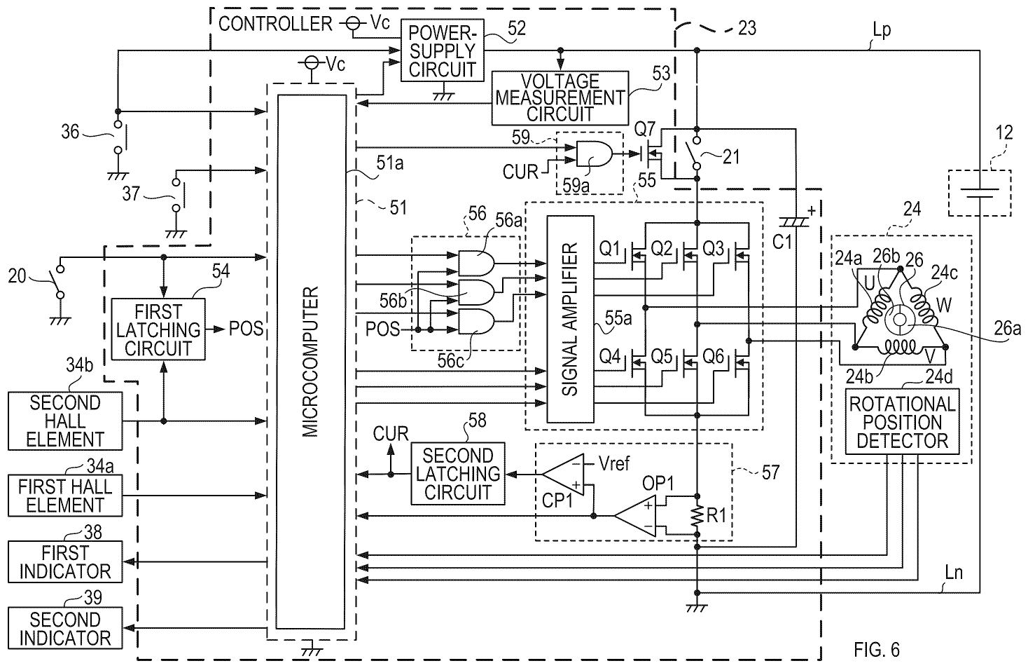

As shown in FIG. 6, the electric motor 24 includes first through third coils 24a through 24c respectively associated with three phases (that is, U-PHASE, V-PHASE, and W-PHASE) of the electric motor 24. The first through third coils 24a through 24c are configured to be sequentially excited so as to generate a rotating magnetic field. In the present embodiment, the first through third coils 24a through 24c form a delta connection. In another embodiment, the first through third coils 24a through 24c may form a star connection (or a wye connection). The rotor 26 (i) includes a first pole 26a and a second pole 26b, and (ii) is configured to rotate when the first pole 26a and the second pole 26b are subjected to the rotating magnetic field generated by the first through third coils 24a through 24c.

The electric motor 24 includes a rotational position detector 24d. The rotational position detector 24d is configured to output first through third pulse signals (or square wave signals) to the controller 23 in accordance with a rotational position of the rotor 26. In the present embodiment, the rotational position detector 24d is a Hall effect sensor. In the present embodiment, each of the first through third pulse signals reverses from positive (or HIGH) to negative (or LOW) or from negative (or LOW) to positive (or HIGH) each time the rotor 26 rotates by 180 electrical degrees. The first through third pulse signals have a phase difference of 60 electrical degrees from each other. In another embodiment, the rotational position detector 24d may be configured to output one pulse signal, instead of the first through third pulse signals, to the controller 23 each time the rotor 26 rotates by 60 electrical degrees. In yet another embodiment, the rotational position detector 24d may be configured to output first through third sine wave signals, instead of the first through third pulse signals, to the controller 23. In this case, the controller 23 may include a waveform conversion circuit configured to convert the first through third sine wave signals into first through third pulse signals. In yet another embodiment, the rotational position detector 24d may be a pulse encoder.

The reciprocating tool 1 includes a power line Lp extending from a positive electrode of the battery pack 12 attached to the battery attachment portion 11 to the controller 23. The reciprocating tool 1 includes a ground line Ln extending from a negative electrode of the battery pack 12 attached to the battery attachment portion 11 to the controller 23. The ground line Ln is coupled to a ground of the reciprocating tool 1 on the controller 23. The battery pack 12 applies its output voltage (hereinafter, referred to as “battery voltage”) between the power line Lp and the ground line Ln.

The controller 23 includes a control circuit 51. In the present embodiment, the control circuit 51 includes a microcomputer 51a. The microcomputer 51a includes a CPU (not shown), a ROM (not shown), a RAM (not shown), an analog-to-digital (A-to-D) converter (not shown), input ports (not shown), and output ports (not shown). In another embodiment, the control circuit 51 may include an additional microcomputer. In yet another embodiment, the control circuit 51 may include a logic circuit (or a wired logic connection) including two or more electronic components, in addition to or in place of the microcomputer 51a. In yet another embodiment, the control circuit 51 may include an ASIC and/or an ASSP, in addition to or in place of the microcomputer 51a. In yet another embodiment, the control circuit 51 may include a PLD on which a reconfigurable logic circuit can be implemented, in addition to or in place of the microcomputer 51a. Examples of the PLD include an FPGA.

The control circuit 51 is coupled to the rotational position detector 24d. The control circuit 51 is configured (i) to receive the first through third pulse signals from the rotational position detector 24d, and (ii) to detect the rotational position of the rotor 26 based on the first through third pulse signals received.

The control circuit 51 is coupled to the main power switch 36. The main power switch 36 includes (i) a first contact coupled to the ground of the reciprocating tool 1 and (ii) a second contact coupled to the control circuit 51. Accordingly, the main power switch 36 is configured to output a first negative logic signal to the control circuit 51 in response to the main power switch 36 being pressed (in other words, turned ON). The control circuit 51 is configured to detect that the main power switch 36 is ON based on the control circuit 51 receiving the first negative logic signal from the main power switch 36.

The control circuit 51 is coupled to the mode selection switch 37. The mode selection switch 37 includes (i) a first contact coupled to the ground of the reciprocating tool 1 and (ii) a second contact coupled to the control circuit 51. Accordingly, the mode selection switch 37 is configured to output a second negative logic signal to the control circuit 51 in response to the mode selection switch 37 being pressed (in other words, turned ON). The control circuit 51 is configured to detect that the mode selection switch 37 is ON based on the control circuit 51 receiving the second negative logic signal from the mode selection switch 37.

The control circuit 51 is coupled to the contact switch 20. The contact switch 20 includes (i) a first contact coupled to the ground of the reciprocating tool 1 and (ii) a second contact coupled to the control circuit 51. Accordingly, the contact switch 20 is configured to output a third negative logic signal to the control circuit 51 in response to the contact switch 20 being pressed (in other words, turned ON) by the pressing member 6 being pressed against a workpiece. The control circuit 51 is configured to detect that the contact switch 20 is ON based on the control circuit 51 receiving the third negative logic signal from the contact switch 20.

The control circuit 51 is coupled to the first Hall element 34a. The first Hall element 34a is configured to output a first position detection signal to the control circuit 51 in response to the first Hall element 34a detecting the south pole of the first magnet 32. In the present embodiment, the first position detection signal is a negative logic signal. In another embodiment, the first position detection signal may be a positive logic signal.

The control circuit 51 is coupled to the second Hall element 34b. The second Hall element 34b is configured to output a second position detection signal to the control circuit 51 in response to the second Hall element 34b detecting the north pole of the second magnet 33. In the present embodiment, the second position detection signal is a negative logic signal. In another embodiment, the second position detection signal may be a positive logic signal.

The control circuit 51 is (i) coupled to the first indicator 38, and (ii) configured to output a first lighting signal to the first indicator 38. The first indicator 38 is configured to be turned ON when receiving the first lighting signal from the control circuit 51.

The control circuit 51 is (i) coupled to the second indicator 39, and (ii) configured to output a second lighting signal to the second indicator 39. The second indicator 39 is configured to be turned ON when receiving the second lighting signal from the control circuit 51.

The controller 23 includes a power-supply circuit 52 coupled to (i) the first contact of the main power switch 36, (ii) the control circuit 51, (iii) the power line Lp, and (iv) the ground. The main power switch 36 is configured to output the first negative logic signal to the power-supply circuit 52, in addition to the control circuit 51. The control circuit 51 is configured to output a remote control (RC) signal to the power-supply circuit 52. In the present embodiment, the RC signal is a negative logic signal. In another embodiment, the RC signal may be a positive logic signal.

The power-supply circuit 52 is configured to maintain its ON-state (i) while receiving the first negative logic signal from the main power switch 36, or (ii) while receiving the RC signal from the control circuit 51. The power-supply circuit 52 is configured to generate, in its ON-state, a fixed direct voltage (hereinafter, referred to as “power-supply voltage”) Vc based on the battery voltage. The power-supply voltage Vc generated by the power-supply circuit 52 is delivered to the rotational position detector 24d, the first Hall element 34a, the second Hall element 34b, the first indicator 38, the second indicator 39, and various circuits on the controller 23, via not shown paths.

The controller 23 includes a voltage measurement circuit 53 configured (i) to measure the battery voltage on the power line Lp, and (ii) to output a battery voltage signal to the control circuit 51. The battery voltage signal is an analog signal having a voltage corresponding to the measured battery voltage.

The controller 23 includes a first latching circuit 54 coupled to (i) the first contact of the contact switch 20 and (ii) the second Hall element 34b. The first latching circuit 54 is configured (i) to hold its output (POS) negative (or LOW) in response to a falling edge (or a negative edge) of the second position detection signal output from the second Hall element 34b, and (ii) to reset its output to positive (or HIGH) in response to the third negative logic signal output from the contact switch 20.

The controller 23 includes a drive circuit 55 coupled to the control circuit 51. The control circuit 51 is configured to output first through sixth pulse-width modulated (PWM) signals to the drive circuit 55. The first through sixth PWM signals share the same cycle. The drive circuit 55 is configured to drive the electric motor 24 in accordance with the first through sixth PWM signals received from the control circuit 51.

More specifically, the drive circuit 55 includes a signal amplifier (or a level shifter) 55a configured to amplify the first through sixth PWM signals received from the control circuit 51.

The drive circuit 55 includes first through sixth switches Q1 through Q6 that form a three-phase full-bridge circuit. The first through third switches Q1 through Q3 are coupled to (i) the power line Lp and (ii) the first through third coils 24a through 24c so as to serve as high-side switches of the three-phase full-bridge circuit. The fourth through sixth switches Q4 through Q6 are coupled to (i) the first through third coils 24a through 24c and (ii) the ground so as to serve as low-side switches of the three-phase full-bridge circuit.

The first through sixth switches Q1 through Q6 are configured to respectively receive the first through sixth PWM signals amplified by the signal amplifier 55a, and to transition into their respective ON-states or OFF-states. In the present embodiment, the first through sixth switches Q1 through Q6 are n-channel metal-oxide semiconductor field-effect transistors (MOSFETs). In another embodiment, at least one of the first through sixth switches Q1 through Q6 may be other types of semiconductor switches including a junction field-effect transistor (JFET), a bipolar transistor, and an insulated gate bipolar transistor (IGBT). In yet another embodiment, each or at least one of the first through sixth switches Q1 through Q6 may be a mechanical relay.

The controller 23 includes a first signal cutoff circuit 56 configured to cut off the first through third PWM signals output from the control circuit 51. More specifically, the first signal cutoff circuit 56 is configured (i) to be disabled while the output (POS) of the first latching circuit 54 is positive, and (ii) to be enabled while the output of the first latching circuit 54 is negative. When the first signal cutoff circuit 56 is disabled, the first through third PWM signals are delivered to the drive circuit 55 via the first signal cutoff circuit 56. When the first signal cutoff circuit 56 is enabled, the first through third PWM signals are cut off from the drive circuit 55 by the first signal cutoff circuit 56.

In the present embodiment, the first signal cutoff circuit 56 includes wired logic. More specifically, the first signal cutoff circuit 56 includes first through third AND gates 56a through 56c. The first through third AND gates 56a through 56c are configured (i) to deliver the first through third PWM signals to the drive circuit 55 while the output of the first latching circuit 54 is positive, and (ii) to cut off the drive circuit 55 from the first through third PWM signals (or to cut off the first through third PWM signals to the drive circuit 55) by setting their respective outputs to negative (or LOW) while the output of the first latching circuit 54 is negative.

The controller 23 includes a current measurement circuit 57 (i) intercoupling (or interconnecting) between the drive circuit 55 and the ground, and (ii) configured to measure a magnitude of an electric current flowing through the electric motor 24 (hereinafter, referred to as “motor current”). The current measurement circuit 57 includes a shunt resistor R1. The shunt resistor R1 includes (i) a first end coupled to the fourth through sixth switches Q4 through Q6 and (ii) a second end coupled to the ground.

The current measurement circuit 57 includes a differential amplifier OP1 configured (i) to measure the magnitude of the motor current flowing through the shunt resistor R1, and (ii) to output a current measurement signal. More specifically, the differential amplifier OP1 is configured to amplify a voltage across the shunt resistor R1 to thereby generate the current measurement signal. Accordingly, the current measurement signal is an analog signal having a voltage corresponding to the magnitude of the motor current. The differential amplifier OP1 may be an open-loop configuration with no negative feedback circuit from its output to its input, or may be a closed-loop configuration with such a negative feedback circuit. The control circuit 51 is configured to receive the current measurement signal.

The current measurement circuit 57 includes a comparator CP1 configured to detect that the trigger switch 21 is ON. More specifically, the comparator CP1 is configured (i) to compare the voltage of the current measurement signal with a preset reference voltage Vref, (ii) to set its output to positive (or HIGH) in response to the voltage of the current measurement signal being greater than the reference voltage Vref, and (iii) to set its output to negative (or LOW) in response to the voltage of the current measurement signal being smaller than or equal to the reference voltage Vref. The reference voltage Vref is equal to or approximate to the voltage of the current measurement signal when an insufficient motor current to be describe later is flowing through the electric motor 24.

The controller 23 includes a second latching circuit 58 configured to hold its output (CUR) positive (or HIGH) in response to the output of the comparator CP1 being positive. The second latching circuit 58 is configured to hold its output positive for at least a period of time (for example, 100 milliseconds) equal to or longer than the cycle of the first through sixth PWM signals, each time the output of the comparator CP1 transitions from negative to positive. The control circuit 51 is configured to receive the output of the second latching circuit 58.

The trigger switch 21 intercouples (or interconnects) between (i) the power line Lp and (ii) the first through third switches Q1 through Q3. More specifically, the trigger switch 21 includes (i) a first contact coupled to the power line Lp, and (ii) a second contact coupled to the first through third switches Q1 through Q3, and is configured to establish or cut off coupling (or connection) between the power line Lp and the first through third switches Q1 through Q3.

The controller 23 includes a seventh switch Q7 coupled to (i) the first contact and (ii) the second contact of the trigger switch 21. The seventh switch Q7 is configured (i) to establish coupling (or connection) between the first contact and the second contact of the trigger switch 21 when in its ON-state, and (ii) to cut off the coupling (or the connection) between the first contact and the second contact of the trigger switch 21 when in its OFF-state. Accordingly, the seventh switch Q7 is configured (i) to couple the power line Lp with the first through third switches Q1 through Q3 via the seventh switch Q7 while the trigger switch 21 is in its OFF-state and the seventh switch Q7 is in its ON-state, and (ii) to uncouple the power line Lp from the first through third switches Q1 through Q3 while the trigger switch 21 is in its OFF-state and the seventh switch Q7 is also in its OFF-state. In the present embodiment, the seventh switch Q7 is an n-channel MOFSET. In another embodiment, the seventh switch Q7 may be other types of semiconductor switches including a JFET, a bipolar transistor, an IGBT, and a solid state relay (SSR). In yet another embodiment, the seventh switch Q7 may be a mechanical relay.

The control circuit 51 is configured to output (i) a switch-ON signal for turning ON the seventh switch Q7, and (ii) a switch-OFF signal for turning OFF the seventh switch Q7. In the present embodiment, the switch-ON signal is a positive logic signal, and the switch-OFF signal is a negative logic signal. In another embodiment, the switch-ON signal may be a negative logic signal, and the switch-OFF signal may be a positive logic signal.

The controller 23 includes a second signal cutoff circuit 59 configured to cut off the switch-ON signal output from the control circuit 51. More specifically, the second signal cutoff circuit 59 is configured (i) to be disabled while the output (CUR) of the second latching circuit 58 is positive, and (ii) to be enabled while the output of the second latching circuit 58 is negative. When the second signal cutoff circuit 59 is disabled, the switch-ON signal is delivered to the seventh switch Q7 via the second signal cutoff circuit 59. When the second signal cutoff circuit 59 is enabled, the switch-ON signal is cut off from the seventh switch Q7 by the second signal cutoff circuit 59.

In the present embodiment, the second signal cutoff circuit 59 includes wired logic. More specifically, the second signal cutoff circuit 59 includes a fourth AND gate 59a. The fourth AND gate 59a is configured (i) to deliver the switch-ON signal to the seventh switch Q7 while the output of the second latching circuit 58 is positive, and (ii) to cut off the seventh switch Q7 from the switch-ON signal (or to cut off the switch-ON signal to the seventh switch Q7) by setting an output of the fourth AND gate 59a to negative (or LOW) while the output of the second latching circuit 58 is negative.

The controller 23 includes an electrolytic capacitor C1 configured to deliver a stable motor current to the electric motor 24. The electrolytic capacitor C1 includes (i) an anode coupled to the first contact of the trigger switch 21, and (ii) a cathode coupled to the ground. In another embodiment, the electrolytic capacitor C1 may be removed.

### 2-4. Electrical Operation of Reciprocating Tool

The above-described electrical configuration operates as follows.

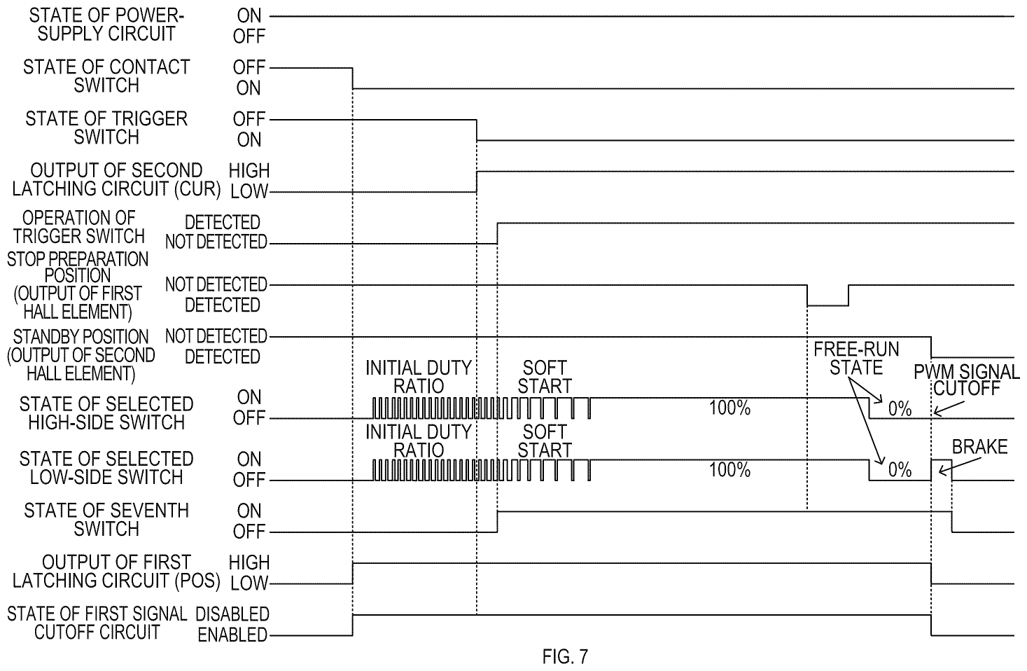

As shown in FIG. 7, when the pressing member 6 is pressed against a workpiece to turn ON the contact switch 20 while the power-supply circuit 52 is in the ON-state, the output (POS) of the first latching circuit 54 is held positive (or HIGH), and the first signal cutoff circuit 56 is disabled. The control circuit 51 detects the rotational position of the rotor 26 based on the first through third pulse signals received from the rotational position detector 24d until this point in time. The control circuit 51 selects (i) one of the high-side switches, and (ii) one of the low-side switches according to a first lookup table stored in the ROM, and outputs the PWM signals corresponding to these selected switches. The first lookup table specifies a combination of the high-side and low-side switches to be selected in association with the rotational position of the rotor 26. The first lookup table is set to select a combination of the high-side and low-side switches that fails the rotor 26 to rotate. More specifically, in the present embodiment, the first lookup table is set to select (i) a combination of the high-side and low-side switches that generates a magnetic field that attracts the first pole 26a of the rotor 26 to the coil (any of the first through third coils 24a through 24c) facing the first pole 26a, or (ii) a combination of the high-side and low-side switches that generates a magnetic field that attracts the second pole 26b of the rotor 26 to the coil (any of the first through third coils 24a through 24c) facing the second pole 26b.

Each of the corresponding PWM signals has an initial duty ratio. The initial duty ratio is greater than zero but insufficient to start the electric motor 24 (for example, 10%). With the initial duty ratio as such, the selected high-side and low-side switches deliver the insufficient motor current to the corresponding one of the first through third coils 24a through 24c. The rotor 26 is configured not to rotate by the insufficient motor current.

When the trigger switch 21 is ON, and the insufficient motor current flows, the output (CUR) of the second latching circuit 58 is held positive (or HIGH), and the second signal cutoff circuit 59 is disabled. When the control circuit 51 detects that the trigger switch 21 is ON based on the output of the second latching circuit 58 being positive, the switch-ON signal is delivered from the control circuit 51 to the seventh switch Q7 to turn ON the seventh switch Q7. Then, the control circuit 51 performs a soft start. In the soft start, the control circuit 51 selects (i) one of the high-side switches and (ii) one of the low-side switches according to a second lookup table stored in the ROM, and outputs the PWM signals corresponding to these selected switches. The second lookup table specifies a combination of the high-side and low-side switches to be selected in association with the rotational position of the rotor 26. The second lookup table is set to select a combination of the high-side and low-side switches that contributes to rotating the rotor 26. The control circuit 51 gradually increases the duty ratio of each of the corresponding PWM signals while performing the soft start.

When the soft start is completed, the control circuit 51 sets the duty ratios of the PWM signals corresponding to the selected high-side and low-side switches to 100%.

When the first Hall element 34a detects that the reciprocating member 18 reaches a stop preparation position, the control circuit 51 starts preparing to stop the electric motor 24. Specifically, the control circuit 51 calculates remaining drive time of the electric motor 24. When the calculated remaining drive time elapses, the control circuit 51 sets the duty ratios of all the first through sixth PWM signals to 0% to bring the electric motor 24 into a free-run state (or coast the electric motor 24).

Next, when the second Hall element 34b detects that the reciprocating member 18 reaches the standby position, (i) the output (POS) of the first latching circuit 54 is reset to negative (or LOW), (ii) the first signal cutoff circuit 56 is enabled, and (iii) the first through third PWM signals are cut off from the first through third switches Q1 through Q3 by the first signal cutoff circuit 56. Almost simultaneously, the control circuit 51 outputs the PWM signals each having a specified duty ratio (for example, 100%) to at least two of the fourth through sixth switches Q4 through Q6 so as to generate dynamic braking (or regenerative braking) in the electric motor 24. As a result, the dynamic braking is generated in the electric motor 24, and the electric motor 24 stops.

When the control circuit 51 detects that the electric motor 24 has stopped based on the first through third pulse signals, the switch-OFF signal is delivered from the control circuit 51 to the seventh switch Q7, and the seventh switch Q7 is turned OFF.

### 2-4-1. Low-Voltage Drive Operation

The battery voltage can drop significantly when a large motor current flows through the electric motor 24 during operation. Such an event can occur when the battery pack 12 has a large internal impedance due to the low temperature of the battery pack 12.

The control circuit 51 of the present embodiment performs a low-voltage drive of the electric motor 24 when such an event occurs.

Specifically, the control circuit 51 stores a first threshold voltage Vth1 and a second threshold voltage Vth2 in the ROM. The first threshold voltage Vth1 is lower than a rated voltage of the battery pack 12. The second threshold voltage Vth2 corresponds to a lower limit of the battery voltage required for the power-supply circuit 52 to generate the power-supply voltage Vc.

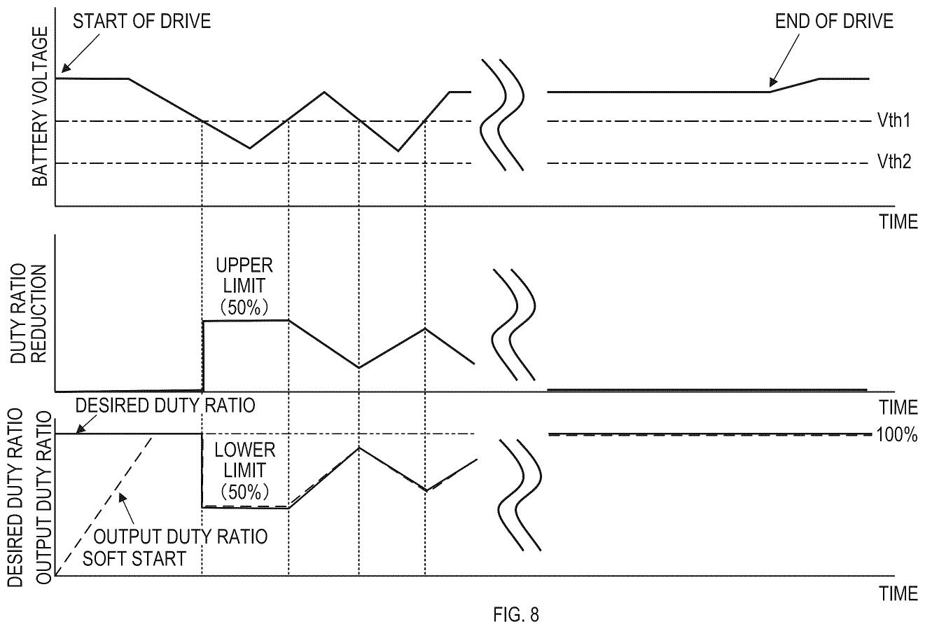

As shown in FIG. 8, when the electric motor 24 starts to be driven and the battery voltage falls below the first threshold voltage Vth1, the control circuit 51 sets an output duty ratio of each of the PWM signals corresponding to the selected high-side and low-side switches to a lower limit duty ratio. The lower limit duty ratio corresponds to a duty ratio for the electric motor 24 to generate a minimum driving force required to drive the reciprocating member 18.

When the motor current is reduced by the lower limit duty ratio, and the battery voltage returns to the first threshold voltage Vth1, the control circuit 51 gradually increases the output duty ratio of each of the corresponding PWM signals at a specified rate of increase over time. With the gradual increase of the output duty ratio, the motor current gradually increases. When the battery voltage falls below the first threshold voltage Vth1 again due to the increase of the motor current as such, the control circuit 51 gradually decreases the output duty ratio of each of the corresponding PWM signals at a specified rate of decrease over time.

The control circuit 51 performs the low-voltage driving as above until the reciprocating member 18 reaches the standby position.

In the present embodiment, the first threshold voltage Vth1 is set higher than the second threshold voltage Vth2 such that the battery voltage exceeds the second threshold voltage Vth2 when the control circuit 51 adjusts the output duty ratio as described above.

The control circuit 51 further stores a third threshold voltage Vth3 and a fourth threshold voltage Vth4 in the ROM. The third threshold voltage Vth3 is (i) higher than the first threshold voltage Vth1, and (ii) lower than the rated voltage of the battery pack 12. The fourth threshold voltage Vth4 is (i) higher than the first threshold voltage Vth1, and (ii) lower than the third threshold voltage Vth3.

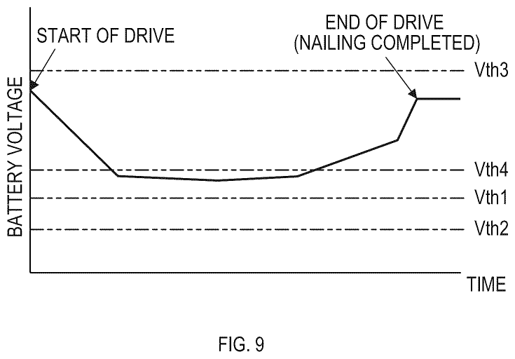

As shown in FIG. 9, when (i) the battery voltage falls below the third threshold voltage Vth3 before an (n−1)th drive (where n is any integer greater than or equal to two) of the electric motor 24, and (ii) the battery voltage falls below the fourth threshold voltage Vth4 during the (n−1)th drive of the electric motor 24, the control circuit 51 disables an output of the PWM signals for an nth drive of the electric motor 24.

When the battery voltage exceeds the third threshold voltage Vth3 before the (n−1)th drive of the electric motor 24, the control circuit 51 enables the output of the PWM signals for the nth drive of the electric motor 24 even if the battery voltage falls below the fourth threshold voltage Vth during the (n−1)th drive of the electric motor 24.

### 2-5. Operation Modes of Reciprocating Tool

As described above, the reciprocating tool 1 is configured to be switched between the single shot mode (or the single firing mode or the sequential firing mode) and the multiple shot mode (or the contact firing mode or the bump firing mode). Operations of the reciprocating tool 1 in the single shot mode and the multiple shot mode are summarized as follows.

In the single shot mode, the reciprocating tool 1 discharges one nail into a workpiece when the trigger 9 is pulled with the pressing member 6 being pressed against the workpiece.

In the single shot mode, the reciprocating tool 1 does not discharge a nail when the pressing member 6 is pressed against a workpiece with the trigger 9 being pulled.

In the multiple shot mode, the reciprocating tool 1 discharges one nail into a workpiece each time the pressing member 6 is pressed against the workpiece with the trigger 9 being pulled.

### 2-6. Processes Executed by Control Circuit

Processes executed by the control circuit 51 (more specifically, the microcomputer 51a) will be described in detail below.

### 2-6-1. Main Routine

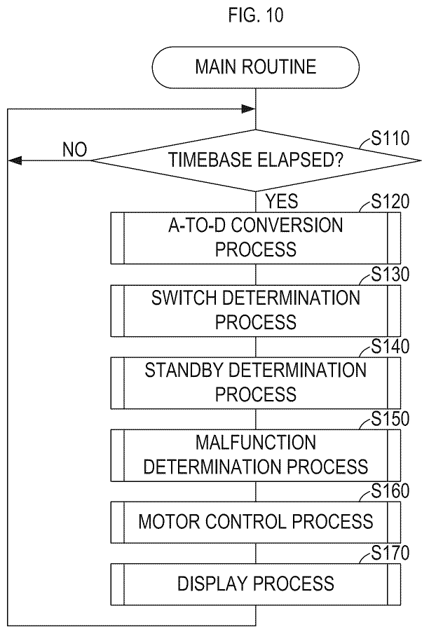

The control circuit 51 repeatedly executes a main routine shown in FIG. 10 during its operation.

As shown in FIG. 10, the control circuit 51 first waits in S110 until a preset timebase elapses (S110: NO). When the timebase elapses (S110: YES), the control circuit 51 proceeds from S120 through S170 sequentially.

In S120, the control circuit 51 executes an A-to-D conversion process. In the A-to-D conversion process, the control circuit 51 converts the battery voltage signal and the current measurement signal into their respective digital values, and stores the digital values in the RAM.

In S130, the control circuit 51 executes a switch determination process. In the switch determination process, the control circuit 51 stores, in the RAM, logic levels of the voltages (positive or negative, or HIGH or LOW, or 1 or 0) received from the main power switch 36, the mode selection switch 37, the contact switch 20, the first Hall element 34a, the second Hall element 34b, and the second latching circuit 58.

In S140, the control circuit 51 executes a standby determination process. In the standby determination process, the control circuit 51 determines whether to transition the reciprocating tool 1 to a standby state.

In S150, the control circuit 51 executes a malfunction determination process. In the malfunction determination process, the control circuit 51 determines whether an error flag is set. The error flag is (i) set when malfunction has occurred, and (ii) cleared when no malfunction has occurred. When the error flag is set, the control circuit 51 performs a predefined operation that corresponds to the malfunction.

In S160, the control circuit 51 executes a motor control process. The motor control process will be described later in detail.

In S170, the control circuit 51 executes a display process. In the display process, the control circuit 51 turns ON the first indicator 38 or the second indicator 39 in accordance with the set operation mode. More specifically, when the reciprocating tool 1 is set to the single shot mode, the control circuit 51 outputs the first lighting signal to the first indicator 38. When the reciprocating tool 1 is set to the multiple shot mode, the control circuit 51 outputs the second lighting signal to the second indicator 39. In addition, when the error flag is set, the control circuit 51 outputs the first lighting signal and the second lighting signal to the first indicator 38 and the second indicator 39, respectively.

### 2-6-2. Interrupting Process

The control circuit 51, in addition to the above-described main routine, executes a not shown interrupting process. In this interrupting process, the control circuit 51 stores logic levels of the voltages (i.e., positive or negative, or HIGH or LOW, or 1 or 0) of the first through third pulse signals in the RAM. In the present embodiment, the control circuit 51 repeats the interrupting process periodically. In another embodiment, the control circuit 51 may execute the interrupting process in response to edges or voltage levels of the first through third pulse signals or other signals.

### 2-6-3. Motor Control Process

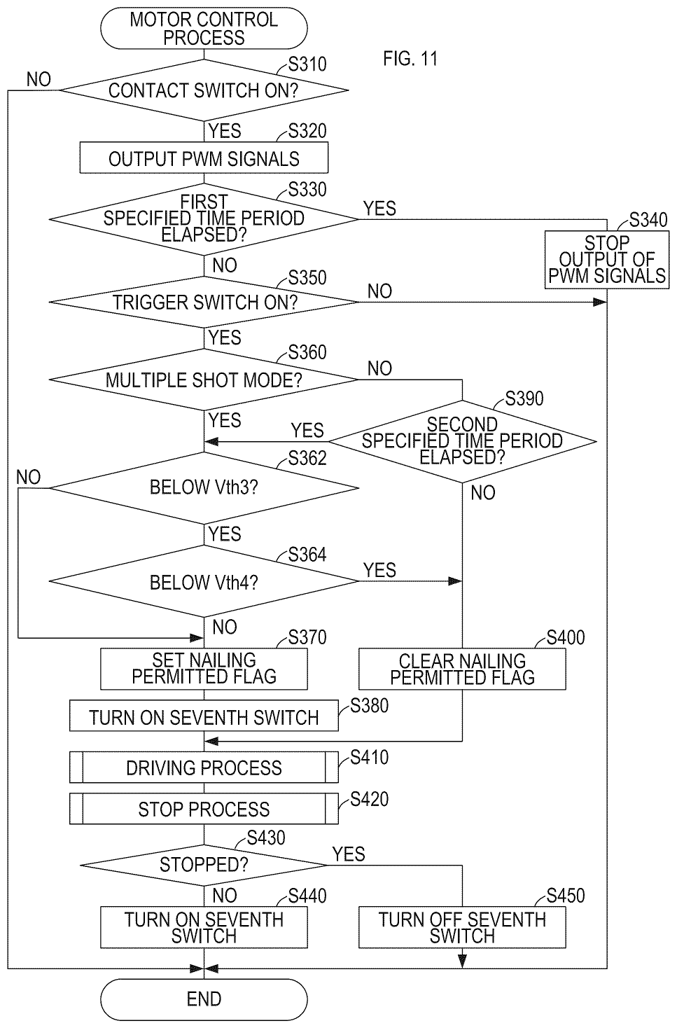

As shown in FIG. 11, in the motor control process, the control circuit 51 first determines whether the contact switch 20 is ON based on the logic level of the voltage of the contact switch 20 stored in the RAM in S310.

When the contact switch 20 is OFF (S310: NO), the control circuit 51 immediately terminates the motor control process. When the contact switch 20 is ON (S310: YES), the control circuit 51 proceeds to S320. In S320, the control circuit 51 outputs the corresponding PWM signals to the selected high-side and low-side switches (in other words, a combination of the high-side and low-side switches that fails the rotor 26 to rotate). Each of the corresponding PWM signals has the above-described initial duty ratio.

In subsequent S330, the control circuit 51 determines whether a first specified time period (for example, 5 seconds) has elapsed since the corresponding PWM signals started to be output. The first specified time period is set to ensure that a nail is not accidentally ejected when the pressing member 6 is held against some object contrary to the user's intention. When the first specified time period has elapsed (S330: YES), the control circuit 51 proceeds to S340 to stop outputting the corresponding PWM signals, and terminates the motor control process.

When the first specified time period has not elapsed (S330: NO), the control circuit 51 proceeds to S350 to determine whether the trigger switch 21 is ON based on the logic level of the output of the second latching circuit 58 stored in the RAM. When the trigger switch 21 is OFF (S350: NO), the control circuit 51 immediately terminates the motor control process.

When the trigger switch 21 is ON (S350: YES), the control circuit 51 proceeds to S360 to determine whether the reciprocating tool 1 is set to the multiple shot mode. More specifically, the control circuit 51 determines whether a multiple shot mode flag is set. The multiple shot mode flag is cleared when the control circuit 51 is activated. In the reciprocating tool 1, each time the user presses the mode selection switch 37, the operation mode of the reciprocating tool 1 is switched between the single shot mode and the multiple shot mode. Accordingly, the control circuit 51 sets or clears the multiple shot mode flag based on the logic level of the voltage of the mode selection switch 37 stored in the RAM.

When the reciprocating tool 1 is set to the multiple shot mode (S360: YES), the control circuit 51 proceeds to S362 to determine whether the battery voltage before the previous drive (i.e., the (n−1)th drive) of the electric motor 24 falls below the third threshold voltage Vth3 based on the digital values of the battery voltage stored in the RAM until this point in time.

When the battery voltage before the previous drive of the electric motor 24 is greater than or equal to the third threshold voltage Vth3 (S362: NO), the control circuit 51 proceeds to S370. When the battery voltage before the previous drive of the electric motor 24 falls below the third threshold voltage Vth3 (S362: YES), the control circuit 51 proceeds to S364.

In S364, the control circuit 51 determines whether the battery voltage falls below the fourth threshold voltage Vth4 during the previous drive of the electric motor 24 based on the digital values of the battery voltage stored in the RAM until this point in time.

When the battery voltage falls below the fourth threshold voltage Vth4 during the previous drive of the electric motor 24 (S364: YES), the control circuit 51 proceeds to S400. When the battery voltage is higher than or equal to the fourth threshold voltage Vth4 during the previous drive of the electric motor 24 (S364: NO), the control circuit 51 proceeds to S370 to set a nailing permitted flag. The nailing permitted flag indicates that a nail is permitted to be driven. In subsequent S380, the control circuit 51 outputs the switch-ON signal to the seventh switch Q7 to turn ON the seventh switch Q7, and proceeds to S410.

When the reciprocating tool 1 is set to the single shot mode (S360: NO), the control circuit 51 proceeds to S390 to determine whether a second specified time period (for example, 50 milliseconds) has elapsed. The second specified time period is set to ensure that the reciprocating tool 1 does not drive a nail when an operation prohibited for the single shot mode, that is, pressing the pressing member 6 against a workpiece with the trigger 9 being pulled, is performed. When the second specified time period has elapsed (S390: YES), the control circuit 51 proceeds to S370.

When the second specified time period has not elapsed (S390: NO), the control circuit 51 proceeds to S400 to clear the nailing permitted flag.

In subsequent S410, the control circuit 51 executes a driving process. The driving process will be described later in detail.

In subsequent S420, the control circuit 51 executes a stop process.

In the stop process, the control circuit 51 clears a motor stopped flag. The motor stopped flag indicates that the electric motor 24 is stopped. Then, the control circuit 51 determines whether the reciprocating member 18 is in the stop preparation position based on the logic level of the voltage of the first Hall element 34a stored in the RAM. When the reciprocating member 18 is in the stop preparation position, the control circuit 51 calculates the remaining drive time of the electric motor 24. When the calculated remaining drive time elapses, the control circuit 51 sets the duty ratios of all the first through sixth PWM signals to 0%, and brings the electric motor 24 into the free-run state.

Then, the control circuit 51 determines whether the reciprocating member 18 is in the standby position based on the logic level of the voltage of the second Hall element 34b stored in the RAM. When the reciprocating member 18 is in the standby position, the control circuit 51 outputs the PWM signals each having the specified duty ratio (for example, 100%) to at least two of the fourth through sixth switches Q4 through Q6 so as to generate the dynamic braking in the electric motor 24.

Then, the control circuit 51 determines whether the electric motor 24 is stopped based on the logic levels of the voltages of the first through third pulse signals stored in the RAM until this point in time. When the electric motor 24 is stopped, the control circuit 51 sets the motor stopped flag.

When the stop process as above is completed, the control circuit 51 proceeds to S430 to determine whether the electric motor 24 is stopped. More specifically, the control circuit 51 determines whether the motor stopped flag is set.

When the electric motor 24 is not stopped (in other words, the motor stopped flag is cleared) (S430: NO), the control circuit 51 proceeds to S440. In S440, the control circuit 51 outputs the switch-ON signal to the seventh switch Q7 to turn ON the seventh switch Q7. In other words, the control circuit 51 continues to output the switch-ON signal to the seventh switch Q7, and holds the seventh switch Q7 in its ON-state.

When the electric motor 24 is stopped (in other words, the motor stopped flag is set) (S430: YES), the control circuit 51 proceeds to S450. In S450, the control circuit 51 outputs the switch-OFF signal to the seventh switch Q7 to turn OFF the seventh switch Q7.

### 2-6-3-1. Driving Process

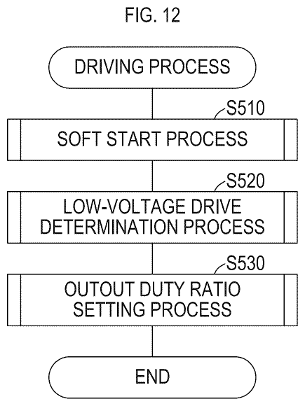

As shown in FIG. 12, in the driving process, the control circuit 51 first executes a soft start process in S510.

In the soft start process, when the nailing permitted flag is set, the control circuit 51 performs the above-described soft start. When the soft start is completed, the control circuit 51 sets the duty ratios of the PWM signals output to the selected high-side and low-side switches (in other words, the high-side and low-side switches that contribute to rotating the rotor 26) to 100%.

When the nailing permitted flag is cleared, or the soft start is completed, the control circuit 51 immediately terminates the soft start process.

In subsequent S520, the control circuit 51 executes a low-voltage drive determination process. The low-voltage drive determination process will be described later in detail.

In subsequent S530, the control circuit 51 executes an output duty ratio setting process. The output duty ratio setting process will be described later in detail.

### 2-6-3-1-1. Low-Voltage Drive Determination Process

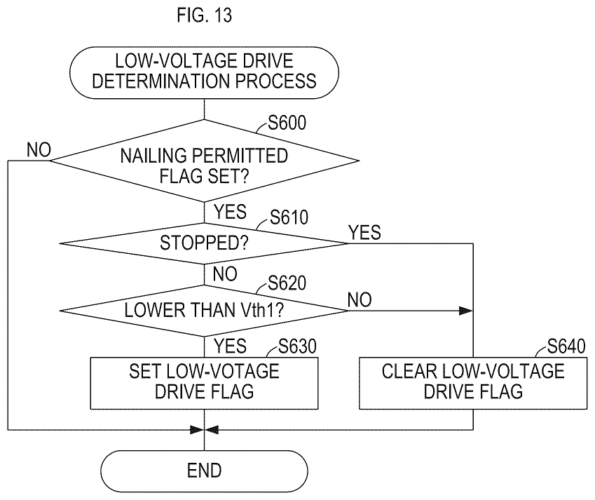

As shown in FIG. 13, in the low-voltage drive determination process, the control circuit 51 first determines whether the nailing permitted flag is set in S600. When the nailing permitted flag is cleared (S600: NO), the control circuit 51 immediately terminates the low-voltage drive determination process.

When the nailing permitted flag is set (S600: YES), the control circuit 51 determines whether the electric motor 24 is stopped based on the motor stopped flag.

When the electric motor 24 is stopped (S610: YES), the control circuit 51 proceeds to S640. When the electric motor 24 is driven (S610: NO), the control circuit 51 proceeds to S620. In S620, the control circuit 51 determines whether the battery voltage falls below the first threshold voltage Vth1 based on the digital value of the battery voltage stored in the RAM.

When the battery voltage falls below the first threshold voltage Vth1 (S620: YES), the control circuit 51 proceeds to S630 to set a low-voltage drive flag. The low-voltage drive flag indicates that the low-voltage drive is determined to be necessary.

When the battery voltage is greater than or equal to the first threshold voltage Vth1 (S620: NO), the control circuit 51 proceeds to S640 to clear the low-voltage drive flag.

### 2-6-3-1-2. Output Duty Ratio Setting Process

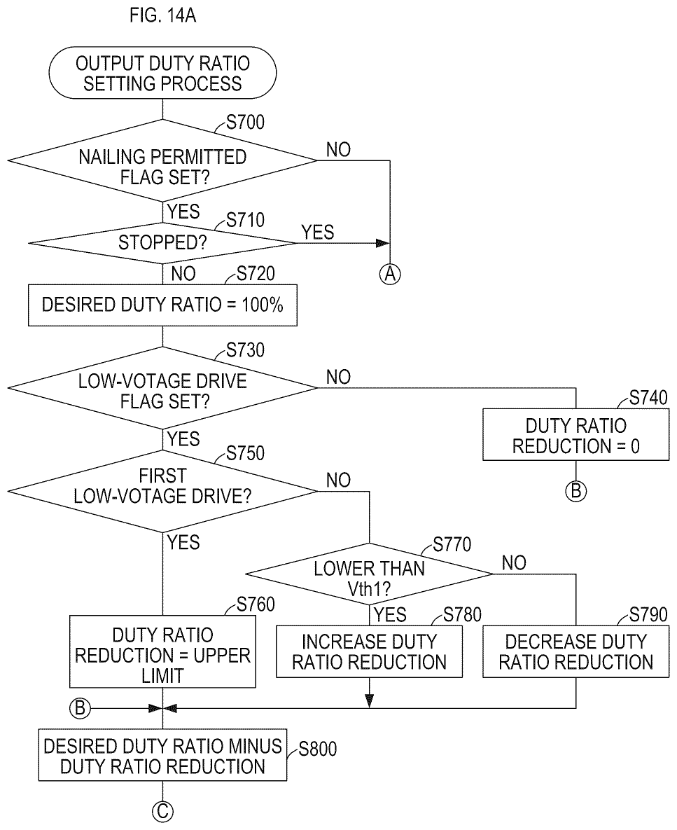

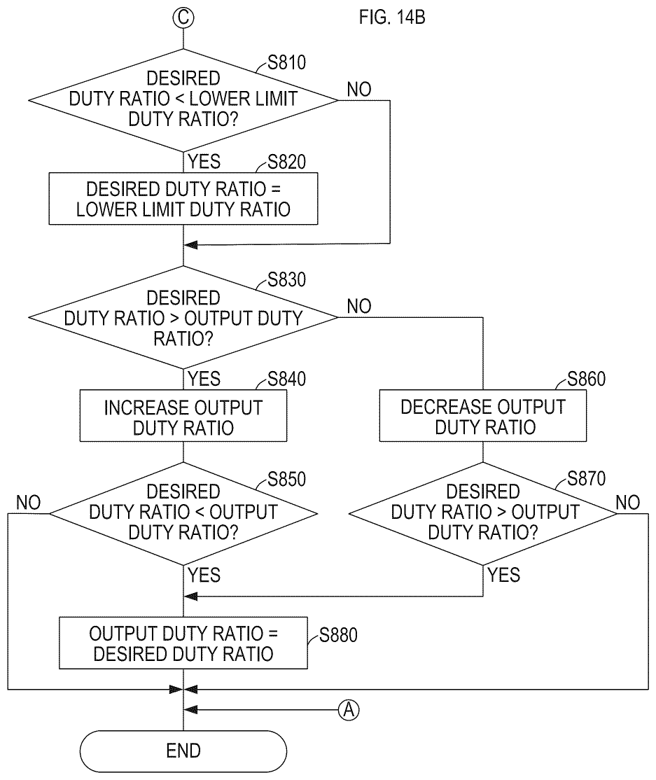

As shown in FIGS. 14A and 14B, in the output duty ratio setting process, the control circuit 51 first determines whether the nailing permitted flag is set in S700. When the nailing permitted flag is cleared (S700: NO), the control circuit 51 immediately terminates the output duty ratio setting process.

When the nailing permitted flag is set (S700: YES), the control circuit 51 proceeds to S710 to determine whether the electric motor 24 is stopped based on the motor stopped flag. When the electric motor 24 is stopped (S710: YES), the control circuit 51 immediately terminates the output duty ratio setting process.

When the electric motor 24 is driven (S710: NO), the control circuit 51 proceeds to S720 to set a desired duty ratio (or a target duty ratio) to 100%.

In subsequent S730, the control circuit 51 determines whether the low-voltage drive flag is set. When the low-voltage drive flag is cleared (S730: NO), the control circuit 51 proceeds to S740 to set a duty ratio reduction to zero, and proceeds to S800.

When the low-voltage drive flag is set (S730: YES), the control circuit 51 proceeds to S750 to determine whether the low-voltage drive flag currently set is the first low-voltage drive flag. When the low-voltage drive flag currently set is the first low-voltage drive flag (S750: YES), the control circuit 51 proceeds to S760 to set the duty ratio reduction to its upper limit (50% in the present embodiment), and then proceeds to S800.

When the low-voltage drive flag currently set is the second or subsequent low-voltage drive flag (S750: NO), the control circuit 51 proceeds to S770 to determine whether the battery voltage falls below the first threshold voltage Vth1.

When the battery voltage falls below the first threshold voltage Vth1 (S770: YES), the control circuit 51 proceeds to S780 to increase the duty ratio reduction by a preset magnitude (3% in the present embodiment), and then proceeds to S800.

When the battery voltage is greater than or equal to the first threshold voltage Vth1 (S770: NO), the control circuit 51 proceeds to S790 to decrease the duty ratio reduction by the predefined magnitude, and then proceeds to S800.

In S800, the control circuit 51 subtracts the duty ratio reduction from the desired duty ratio, and proceeds to S810. In S810, the control circuit 51 determines whether the desired duty ratio is smaller than the lower limit duty ratio. When the desired duty ratio is greater than or equal to the lower limit duty ratio (S810: NO), the control circuit 51 proceeds to S830.

When the desired duty ratio is smaller than the lower limit duty ratio (S810: YES), the control circuit 51 proceeds to S820 to set the desired duty ratio to the lower limit duty ratio.

In subsequent S830, the control circuit 51 determines whether the desired duty ratio is greater than the output duty ratio. When the desired duty ratio is greater than the output duty ratio (S830: YES), the control circuit 51 proceeds to S840 to increase the output duty ratio by a preset magnitude (3% in the present embodiment).

In subsequent S850, the control circuit 51 determines whether the desired duty ratio is smaller than the output duty ratio. When the desired duty ratio is smaller than the output duty ratio (S850: YES), the control circuit 51 proceeds to S880. When the desired duty ratio is greater than or equal to the output duty ratio (S850: NO), the control circuit 51 terminates the output duty ratio setting process.

In S830, when the desired duty ratio is smaller than or equal to the output duty ratio (S830: NO), the control circuit 51 proceeds to S860 to decrease the output duty ratio by a preset magnitude (3% in the present embodiment).

In subsequent S870, the control circuit 51 determines whether the desired duty ratio is greater than the output duty ratio. When the desired duty ratio is smaller than or equal to the output duty ratio (S870: NO), the control circuit 51 terminates the output duty ratio setting process. When the desired duty ratio is greater than the output duty ratio (S870: YES), the control circuit 51 proceeds to S880.

In S880, the control circuit 51 sets the output duty ratio to the desired duty ratio, and terminates the output duty ratio setting process.

Through the output duty ratio setting process described above, the control circuit 51 sets the output duty ratio of each of the PWM signals corresponding to the selected high-side and low-side switches. Consequently, the PWM signals having the set output duty ratio are delivered to the selected high-side and low-side switches.

### 2-7. Technical Effects in Embodiment

In the reciprocating tool 1 configured as described above, even if the battery voltage falls below the first threshold voltage Vth1 while the electric motor 24 is driven, the electric motor 24 can continue to be driven, and further the reciprocating member 18 can be inhibited from being stopped in an inappropriate position.

Also, in the reciprocating tool 1, it is possible to inhibit the control circuit 51 from stopping its operation due to the battery voltage falling below the second threshold voltage Vth2 while the electric motor 24 is driven, and thus possible to inhibit the reciprocating member 18 from being stopped in an inappropriate position.

Also, in the reciprocating tool 1, by setting the lower limit duty ratio in the first low-voltage drive, the motor current flowing from the battery pack 12 to the electric motor 24 can be quickly reduced without stopping the reciprocating member 18. Consequently, the battery voltage can quickly increase.

Also, in the reciprocating tool 1, when the battery voltage changes from smaller than the first threshold voltage Vth1 to greater than or equal to the first threshold voltage Vth1 while the electric motor 24 is driven, the battery voltage can increase while an excessive motor current is inhibited from flowing through the electric motor 24.

Also, in the reciprocating tool 1, when the battery voltage falls below the first threshold voltage Vth1 again, the motor current can be slowly reduced.

Also, in the reciprocating tool 1, the reciprocating member 18 can be driven from its bottom dead center to its top dead center with the torque proportional to the deceleration ratio of the reducer 27. Consequently, even if the motor current is largely reduced while the electric motor 24 is driven, the reciprocating member 18 can continue to be driven.

Also, in the reciprocating tool 1, the electric motor 24 can be inhibited from being accidentally driven when the pressing member 6 is not pressed against a workpiece, in other words, when the user is not machining a workpiece.

### 2-8. Correspondence Between Terms

In the present embodiment, the top dead center of the reciprocating member 18 corresponds to an example of the first dead center in Overview of Embodiments, and the bottom dead center of the reciprocating member 18 corresponds to an example of the second dead center in Overview of Embodiments. Each of the first through sixth PWM signals corresponds to an example of the drive signal in Overview of Embodiments, and the trigger switch 21 corresponds to an example of the first manual switch in Overview of Embodiments. The contact switch 20 corresponds to an example of the second manual switch in Overview of Embodiments, and the battery pack 12 corresponds to an example of the battery in Overview of Embodiments.

### 2-9. Variations

The present disclosure is not limited to the above-described embodiment, and can be practiced in various manners.

In one variation, the standby position of the reciprocating member 18 may differ from the position to stop the reciprocating member 18.

### 2-10. Supplementary Explanation

Two or more functions achieved by one element of the above-described embodiment may be achieved by two or more elements. One function achieved by one element may be achieved by two or more elements. Two or more functions achieved by two or more elements may be achieved by one element. One function achieved by two or more elements may be achieved by one element. A part of the configurations in the above-described embodiment may be omitted. At least a part of the configurations in the above-described embodiment may be added to or replaced with another part of the configurations in the above-described embodiment.

What is claimed is:

1. A reciprocating tool comprising:
a reciprocating member configured to reciprocate between first dead center and second dead center;
an electric motor configured to generate a driving force;
a transmission device configured to transmit the driving force of the electric motor to the reciprocating member at least in a stroke of the reciprocating member from the second dead center to the first dead center;
a drive circuit configured (i) to receive a drive signal for driving the electric motor, and (ii) to deliver a motor current from a battery to the electric motor to thereby drive the electric motor, in accordance with the drive signal received; and
a control circuit configured (i) to output the drive signal to the drive circuit, and (ii) to adjust the drive signal, in response to a first condition being satisfied, such that the drive circuit reduces the motor current to thereby continue to drive the electric motor, the first condition being satisfied in response to (i) the drive circuit driving the electric motor, and (ii) a battery voltage falling below a first threshold voltage, the battery voltage being output from the battery, and the first threshold voltage being lower than a rated voltage of the battery.

2. The reciprocating tool according to claim 1, further comprising:
a power-supply circuit configured to generate, based on the battery voltage, a power-supply voltage for operating the control circuit, wherein:
the first threshold voltage is set higher than a second threshold voltage such that the battery voltage exceeds the second threshold voltage when the control circuit adjusts the drive signal in response to the first condition being satisfied; and
the second threshold voltage corresponds to a lower limit of the battery voltage required for the power-supply circuit to generate the power-supply voltage.

3. The reciprocating tool according to claim 1, wherein:
the drive signal is in the form of a pulse-width modulated signal having an output duty ratio; and
the drive circuit is configured to deliver, to the electric motor, the motor current based on the output duty ratio.

4. The reciprocating tool according to claim 3,
wherein the control circuit is configured to reduce the output duty ratio to a duty ratio capable of driving the reciprocating member in response to the first condition being satisfied.

5. The reciprocating tool according to claim 4, wherein:
the control circuit is configured to gradually increase the output duty ratio at a specified rate of increase over time in response to a second condition being satisfied;
the second condition is satisfied in response to (i) the drive circuit driving the electric motor and (ii) the battery voltage changing from a first magnitude to a second magnitude;
the first magnitude is smaller than the first threshold voltage; and
the second magnitude is greater than or equal to the first threshold voltage.

6. The reciprocating tool according to claim 4, wherein:
the control circuit is configured to set the output duty ratio to a lower limit duty ratio in response to the first condition being satisfied; and
the lower limit duty ratio corresponds to a duty ratio for the electric motor to generate a minimum driving force required for driving the reciprocating member.

7. The reciprocating tool according to claim 6, wherein:
the control circuit is configured to gradually reduce the output duty ratio at a specified rate of decrease over time in response to a third condition being satisfied; and
the third condition is satisfied in response to the output duty ratio being set to the lower limit duty ratio and the battery voltage subsequently falling below the first threshold voltage again.

8. The reciprocating tool according to claim 1, wherein:
the control circuit is configured to disable an output of the drive signal for an nth drive of the electric motor in response to a fourth condition being satisfied, n being any integer greater than or equal to two;
the fourth condition is satisfied in response to (i) the battery voltage falling below a third threshold voltage before an (n−1)th drive of the electric motor, and (ii) the battery voltage falling below a fourth threshold voltage during the (n−1)th drive of the electric motor;
the third threshold voltage is higher than the first threshold voltage; and
the fourth threshold voltage is (i) higher than the first threshold voltage, and (ii) lower than the third threshold voltage.

9. The reciprocating tool according to claim 8, wherein:
the control circuit is configured to enable the output of the drive signal for the nth drive of the electric motor in response to a fifth condition being satisfied; and
the fifth condition is satisfied in response to the battery voltage exceeding the third threshold voltage before the (n−1)th drive of the electric motor.

10. The reciprocating tool according to claim 1,
wherein the transmission device includes a reducer (i) having a preset deceleration ratio, and (ii) configured to convert the driving force of the electric motor into a decelerated output and transmit the decelerated output to the reciprocating member.

11. The reciprocating tool according to claim 1, further comprising
a first manual switch configured to be manually operated by a user of the reciprocating tool,
wherein the control circuit is configured to output the drive signal to the drive circuit in response to at least the first manual switch being or having been manually operated.

12. The reciprocating tool according to claim 11, further comprising:
a pressing member configured to be pressed against a workpiece by the user; and
a second manual switch configured to be manually operated by the pressing member being pressed against the workpiece,
wherein the control circuit is configured to output the drive signal to the drive circuit based on both the first manual switch and the second manual switch being or having been manually operated.

13. The reciprocating tool according to claim 1, further comprising:
a cylinder containing compressed gas therein; and
a piston that (i) is inside the cylinder, and (ii) urges the reciprocating member toward the second dead center by the compressed gas, wherein
the reciprocating member is configured to be driven from the first dead center to the second dead center by the piston.

14. The reciprocating tool according to claim 13,
wherein the reciprocating member is configured (i) to be positioned at the first dead center in response to the piston being positioned at its top dead center, and (ii) to be positioned at the second dead center in response to the piston being positioned at its bottom dead center.

15. The reciprocating tool according to claim 1, wherein:
the transmission device includes a cam (i) including an outer circumference having two or more pins aligned in a circumferential direction of the cam, and (ii) configured to rotate by the driving force of the electric motor; and
the reciprocating member (i) extends between the first dead center and the second dead center, (ii) includes two or more racks in its extending direction, and (iii) is configured to be driven from the second dead center to the first dead center by each of the two or more racks engaging with a corresponding one of the two or more pins.

16. The reciprocating tool according to claim 1, further comprising
a battery attachment portion configured such that the battery is detachably attached thereto.

17. A method for controlling an electric motor in a reciprocating tool, the method comprising:
outputting, to a drive circuit of the reciprocating tool, a drive signal for driving the electric motor, the drive circuit being configured to deliver a motor current from a battery to the electric motor to thereby drive the electric motor in accordance with the drive signal;
transmitting a driving force of the electric motor to a reciprocating member of the reciprocating tool, the reciprocating member being configured to reciprocate between first dead center and second dead center, the driving force being transmitted at least from the second dead center to the first dead center; and
adjusting the drive signal such that the drive circuit reduces the motor current to thereby continue to drive the electric motor, in response to (i) the electric motor being driven, and (ii) a battery voltage falling below a threshold voltage, the battery voltage being output from the battery, and the threshold voltage being lower than a rated voltage of the battery.
